(19) United States
(12) Patent Application Publication
(10) Pub. No.: US 2015/0107156 A1
(43) Pub. Date: Apr. 23, 2015

(54) MANUFACTURING TECHNIQUE AND ASSOCIATED PRODUCT

(71) Applicant: WaterGain Limited, Hamilton (NZ)

(72) Inventor: Jeffrey John Sharp, Hamilton (NZ)

(21) Appl. No.: 14/397,398

(22) PCT Filed: Apr. 19, 2013
(86) PCT No.: PCT/NZ2013/000073

§ 371 Date: Oct. 27, 2014

(30) Foreign Application Priority Data
Apr. 27, 2012 (NZ) 597131

(51) Int. Cl. A01G 9/02; A01G 27/02; B29C 45/00

(52) U.S. Cl. CPC A01G 9/02; B29C 45/00; A01G 27/02; B29L 2023/00
USPC 47/79; 264/328.1; 47/65.5

(57) ABSTRACT

This invention relates to a method of injection moulding a multi-planter having multiple apertures in the sides thereof, and an cap piece integrally formed with the tubing, the method characterised by the step of inserting supports through the apertures to provide support for the internal core portion of the tool used in the injection moulding.

### TECHNICAL FIELD

This invention relates to a manufacturing technique and associated product.

In particular, the present invention is highly applicable to the manufacture of multi-planters, although this should not be seen to be limiting.

### BACKGROUND ART

Multi-planters are a well known product commonly sold at garden centres and the like. A typical form has a central soil reservoir held within a container which has multiple holes in the sides thereof. Plants are placed through the holes into the container so their roots have access to the soil within the reservoir while the plant foliage (and flowers and fruit where applicable) extend outside of the container. Multi-planters are commonly used for the likes of strawberries, herbs and flowering annuals and perennials.

Traditionally these planters have been made from wood and terracotta but more recently plastic injection moulded containers have also been introduced to the market.

Also typically, most of these products are designed to have a small “footprint” and sit on the ground as a space saving device. However, quite recently there has been designed a multi-planter that is capable of being mounted on a wall. This is disclosed in US Pat. Design No. D631,683.

In addition to providing greater versatility and aesthetics as to where a multi-planter can be positioned, this design has also addressed a key problem associated with multi-planters which is watering.

Most multi-planters are watered from the top of the planter, which often results in uneven distribution of water throughout the planter with some of the roots of the plants not receiving sufficient water in order to keep the plants alive.

Some attempts have been made to address this problem with some planters having a perforated tube which goes down the middle of the planter. A hose is then placed on the end of this tube (at the top of the planter) and causes the water to flow through to the bottom of the planter and hopefully distributing water evenly throughout the soil.

It should also be noted that this method of watering would also be unsuitable for a planter which is mounted on a wall as it may be difficult to reach the top of the planter in order to water it.

This problem was addressed in the multi-planter in US D631,683 by the inclusion of a port at the base of the planter to which a hose can be attached. Extending from the port within the planter is a porous conduit through which water flows upwards into the planter then distributed throughout the soil accordingly.

However, there are problems associated with the manufacture of such a useful feature.

The intricate nature of the watering mechanism means that in most cases the planter is required to be plastic injection moulded.

To do this, the tube forming the main body of the planter is injection moulded with two open ends. One of the open ends is required so that the core portion of the injection mould is able to be retracted from the container moulding at the end of the moulding cycle. The other open end of the containing is required because the core portion of the tool must be locked into the cavity of the tool to support it through the moulding cycle. Without this, the core portion is prone to moving out of position as the forces from the injected plastic act on the core portion. This can cause the mould cavity to fill unevenly causing reject mouldings or damaging the injection mould.

The resultant effect of this process is that the base of the planter (which preferably has the watering mechanism) is required to be moulded separately to the main container. Additional manufacturing processes are costly and also adds an additional step at assembly—again leading to more costs.

An alternative to requiring additional assembly at the factory, is to have the parts separate within packaging for the consumer to assemble. However this is a deterrent against buying the product and something that the manufacturer would prefer to avoid.

Another problem of manufacturing planters with this process is that wall thicknesses could be relatively large. This is because the support provided to the core from the end of the moulding is insufficiently strong to bear the extra pressures required to provide thinner wall thicknesses.

It should be appreciated that the thinner the wall thickness, the cheaper the product is to manufacture and also the less expensive it is to freight that product.

Another problem associated with vertical multi-planters is at times, it is desirable to have them oriented at other angles—say horizontally—for example when wanting to have herbs or flowers grown on a windowsill.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DISCLOSURE OF THE INVENTION

According to one aspect of the present invention there is provided a method of injection moulding a multi-planter having
multiple apertures in the sides thereof, and
an end piece integrally formed with the tubing,
   the method characterised by the step of
inserting supports through the apertures to provide support for the internal core portion of the tool used in the injection moulding.

According to another aspect of the present invention there is provided a multi-planter formed by the above process.

It should be appreciated that the shape of the multi-planter can vary according to the design parameters. However, for aesthetic reasons it is thought that the shape of the container would be cylindrical in preferred embodiments—although this should not be seen to be limiting, and other shapes could include square, oval, half round, wedge and triangular in cross-section.

A key aspect of the present invention is the choice of aperture sizes and positioning in the walls of the multi-planter. It should be appreciated that these apertures have a dual function one being that for the end use of the product and the other for the manufacture of the product.

For example, in the manufacture of the product with the present invention, the apertures must be large enough to enable the entry of supporting pins in the tool that hold the core portion of the tool in position as plastic is injected into the cavity of the tool. The pins must be sufficiently large and strong enough to support the core through the pressures engendered by the injection process. Otherwise, the core portion could move out of position causing the mould cavity to fill unevenly. This could cause reject mouldings or even damage the injection mould.

However, at the end use of the product, the apertures are used to support the plants placed in the multi-planter. Thus, if the holes are too large, sufficient support is not provided to the plants causing them to either fall out of the container, or at the very least spoil the aesthetics of the multi-planter.

Having regard to the foregoing, in preferred embodiments it is envisaged that a range for the aperture size should be between 3% and 12% of the total container wall area. This appears to be a ratio that gives the support required during the moulding process as well as to the plants once the container is used for its end purpose.

In particular, the inventor has discovered the percentage of 7% aperture size to wall area works particularly well.

In a typical sized multi-planter, this leads to the apertures having diameters (if circular) in the order of 35 to 45 mm. It should be appreciated that in the industry a common aperture diameter is 40 mm as this corresponds to the size of the root and soil mass of most seedlings desired to be placed into a planter.

It should be appreciated that by manufacturing a multi-planter using the above technique enables an end cap to be manufactured integrally with the container as there is no need to use the open end to support the core portion. This obviates the need for separate assembly which was either required to be done at the factory or by the consumer through insertion of pins to hold the end cap to the bottom of the container.

It should be appreciated that the present invention also enables the end cap to be made considerably smaller than one which had to be produced separately. This effectively reduces the height of the container while still enabling the same number of apertures to be available for planting. The resultant lower height leads to reduced packaging being required and an extra layer of product being able to be accommodated within container shipping. It should be appreciated that this also leads to considerable cost savings.

Moreover, costs are also saved as a consequence of less plastics material being required to be used within the manufacture of the present invention.

As a general rule, the thinner the wall thickness, the higher the load on the core from the injection moulding process. By having a number of support pins providing additional and distributed support, the core can withstand higher pressures allowing a thinner wall to be produced—say from the previous 6 mm to only 3 mm thick. This reduces the average weight of a planter from 1 kg to 640 g—again saving in freight costs. This also means that the planter can be more readily mounted providing less strain on the mounting lugs and vertical surface.

In addition to saving weight through this manufacturing process, the less material used leads to a 30% to 40% reduction in costing. It can be seen therefore that this present invention provides a manufacturing method that gives considerable competitive advantage.

While having a thinner wall thickness is desirable for many reasons, it can provide an illusion of “cheapness”. Thus, in some embodiments of the present invention the mould is constructed to provide a thickening in the wall around the apertures giving the illusion of a thick wall throughout.

From a manufacturing perspective this can be difficult to achieve as an undercut is required making it problematic to pull the core out of the mould.

The dept of the undercut is determined by testing and is effected by the flexural properties of the polymer used to manufacture the product, the design of the undercut and also the settings of the moulding machine. In preferred embodiments of the present invention the relationship between the outer perimeter length and the additional thickness of the undercut is in the range of 0.6-1.0%. The inventor has found that 0.8% works particularly well.

In one embodiment, the end cap is plain in construction and merely acts to keep in potting mix with which the container is filled.

However, in preferred embodiments of the present invention the end cap also includes a connection to watering devices such as hoses. This is a particularly useful feature for when the multi-planter is mounted on a vertical surface.

In some embodiments of the present invention, the hose connection may be in the form of a recessed nipple into the side of the container. This enables the planter to fit better into the square footprint of conventional packaging again saving packaging space and providing economies of scale for shipping.

While in some embodiments the hose connection may be positioned at the front of the planter (to withstand typical water pressures), it may in other embodiments be placed at the side of the container so to intrude less in terms of visual aesthetics.

In some embodiments, the present invention, the pre-moulded cap into the multi planter may also be in the form of a water reservoir. This could provide ongoing water supply to the planters thereby requiring less watering of the planter. In some embodiments there could be provided a conduit or some type of capillary based mechanism that assists in the distribution of water from the water reservoir into the soil as the soil dries out.

As discussed in the Background Art, most multi-planters are positioned on the ground are generally watered from the top letting gravity distribute the water throughout the potting mix within the container. However, with the present invention it would be impractical to try and water a vertically mounted planter from the top in terms of gaining ready access to the top of the planter. Thus, having a hose connection at the base of the planter makes watering considerably easier.

It is envisaged that by utilising a one piece injection moulded container other features could be moulded therein to increase the versatility of the container. For example, the container may also including wall mounting lugs making the vertical surface mounting easier to achieve.

In the planter described in United States Pat. Design No. D631683, the planter had apertures at the back thereof which fitted onto a mounting bracket. However, this could be problematic leading to leakage of water and soil from those apertures. Therefore in preferred embodiments of the present invention the mounting lugs are in the male form thus obviating the need for holes through which water and soil could escape from the container.

In some embodiments, there may be included an attachment mechanism for hanging handles or straps enabling the multi planter to hang from brackets or roof structures.

In some embodiments of the present invention it will be desirable to have flexibility around the orientation by which the multi-planter could be placed, say angled on a wall.

In a preferred embodiment it may be desirable to use the multi-planter in a horizontal orientation on a windowsill for say growing herbs.

According to yet another aspect of the present invention there is provided a multi-planter including
a tubular main body having multiple apertures therein through which plants can be placed, and
support mechanisms enabling the multi-planter to be hung vertically, angled or rest horizontally, and
end caps for each end of the tube.

Thus, in preferred embodiments the multi-planter is supplied with an additional end cap that fits over what normally would be the top end of the planter so as to contain potting mix therein. This can enable the planter to be placed in a non-vertical position as well.

Preferably, the wall mounting lugs (or associated brackets) are shaped so as to provide a base preventing the planter from rolling when placed in that position.

In preferred embodiments of the present invention the planters are also supplied with a number of plugs which can be used to seal the aperture. For example, when the present invention is being used in the horizontal orientation, the plugs may be inserted in the bottom-most apertures to prevent soil and water from escaping.

The plugs may come in any form, but in one embodiment it is envisaged that they be made of a flexible rubber, plastics or silicon product (much like the plugs commonly used in piggy banks) thereby allowing ready insertion, and sealing.

It can be seen that the present invention provides a number of advantages over the prior art.

Firstly, there is provided a means by which a one piece injection moulded container can be produced with an end cap and optionally a water connection already in place. This saves assembly and provides an aesthetically pleasing product.

The present invention also provides a versatile product which can be mounted on the wall, hung from a vertical structure or placed horizontally.

However, a significant advantage of the present invention is the ability to produce a container having much thinner walls which represents a saving in plastics material and weight—thereby leading to a cost savings in the order of 30% to 40% over similar products.

### BRIEF DESCRIPTION OF DRAWINGS

Further aspects of the present invention will become apparent from the following description which is given by way of example only and with reference to the accompanying drawings in which:

FIG. 1 is a section view of the container showing holes formed by the support pins, moulded in end plate, connection mechanism for the watering hose;

FIG. 2 is a section view of previous injection moulds that support the core portion at both ends,

FIG. 3 is a section view showing the injection mould supporting pins, supporting the core portion of the mould,

FIG. 4 is a side elevation of the container showing a hanging strap,

FIG. 5 is a section view of the container showing the attachment of the hanging strap, and

FIG. 6 is a section view of an optional cap for closing in the open end of the container,

FIG. 7 illustrates a mounting bracket, and

FIG. 8 illustrates a desired design ratio.

### BEST MODES FOR CARRYING OUT THE INVENTION

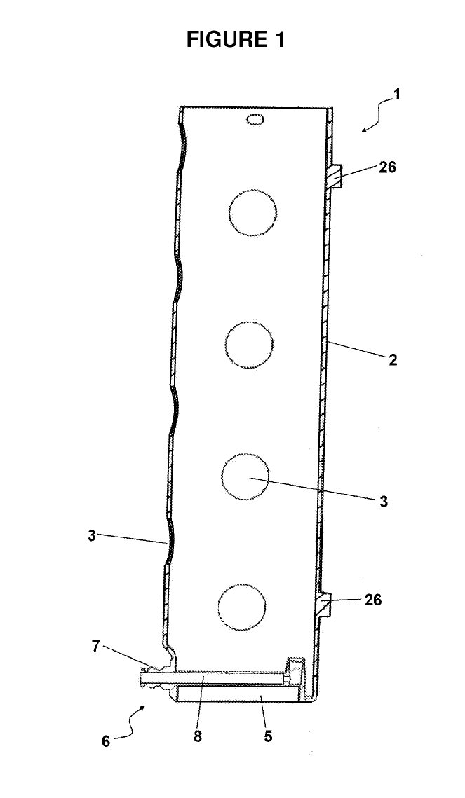

FIG. 1 is a cross-sectional view of the lower portion of a multi-planter generally indicated by arrow (1).

In this embodiment, the multi-planter (1) is substantially cylindrical in shape, although it should be appreciated that other shapes may be employed.

The multi-planter (1) has a back wall (2) which does not contain any apertures therein. It is envisaged that when the multi-planter (1) is mounted vertically, it is this wall (2) that will be placed against the vertical surface. Further, when the multi-planter (1) is position in a horizontal orientation, it is this wall which will be closest to the ground surface.

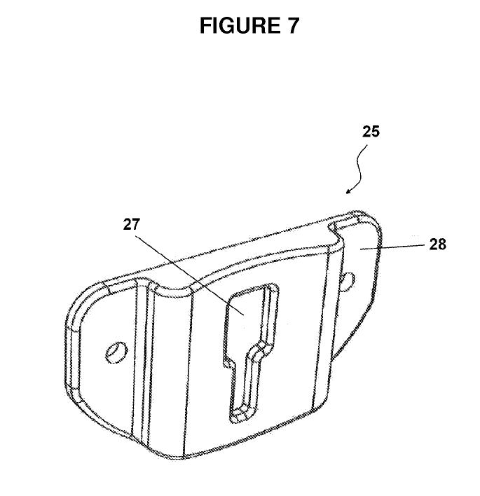

Mounting lugs (26) extend out of the back wall (2) and can engage with the mounting bracket (25) illustrated in FIG. 7.

In contrast, the rest of the walls of the container (1) contains a number of apertures (3).

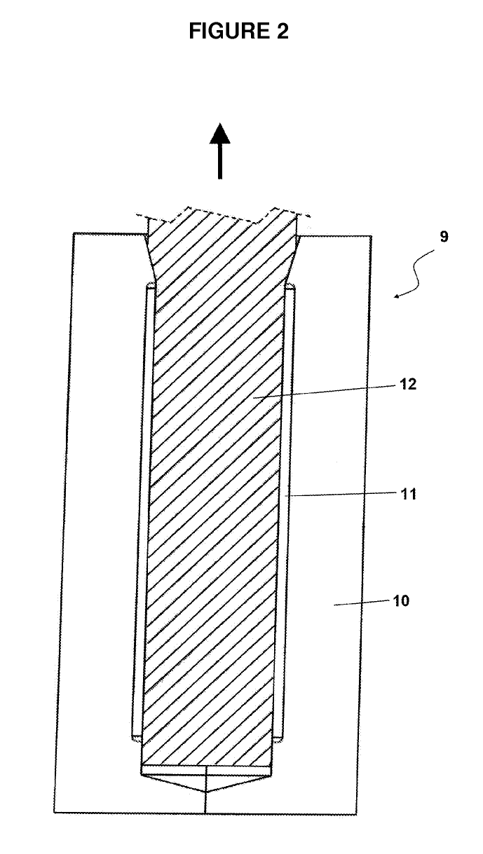

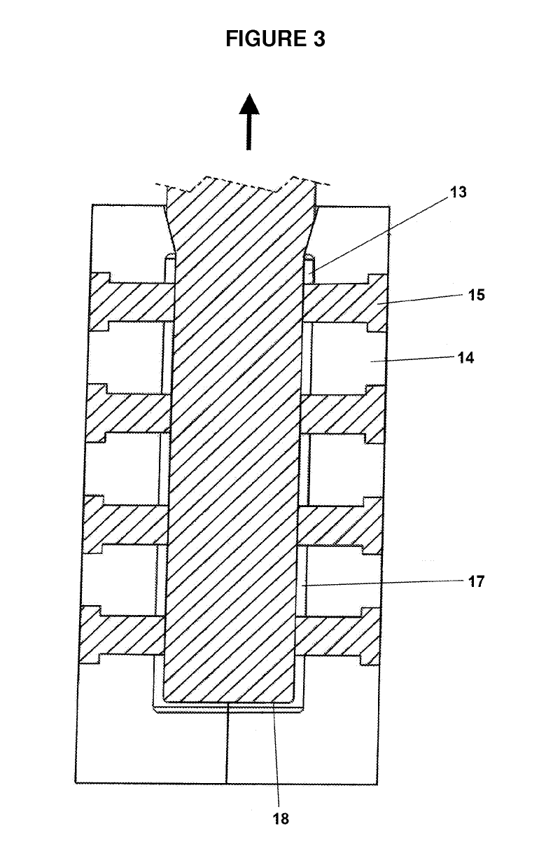

Apertures (3) are formed by support pins during the moulding process which also act to support the core portion (see FIGS. 2 and 3) during the moulding process.

The size of the apertures (3) relative to the surface area of the walls of the multi-planter (1) is roughly 7%. It has been found that this particular ratio enables support pins to support the core, while not providing too large an aperture to support plants when in use. In this embodiment the apertures have a diameter of 40 mm.

Generally indicated by arrow (4) of the multi-planter (1) is a moulded end plate (5). The end plate (5) prevents potting mix within the multi-planter (1) from escaping.

Also moulded into the multi-planter (1) and positioned just above the end cap (5) is a watering hose connector generally indicated by arrow (6). The connection (6) includes a nipple (7) which can connect to the end of the watering hose and a conduit (8) through which the water can enter the interior of the planter (1). A perforated hose (or in some embodiments a spongy tube) may be positioned over the end of the conduit (8) to convey water through to the entire interior of the planter (1).

FIG. 2 is a sectional view of a previous injection moulding process generally indicated by arrow (9). The injection mould (9) consists of walls (10) which define an internal cavity (11). Within the cavity (11) is a core (12). The core (12) is supported through apertures at both ends of the mould (10). After moulding, the cone must retract to release the moulding and this is shown by the arrow in FIG. 2.

In contrast, FIG. 3 illustrates how the present invention can use the apertures (13) within a moulding (14) to accommodate support pins (15) which act to support the core (16) within the cavity (17). Thus, this enables an end plate (18) to be accommodated during the moulding process as this is not required for support pins to access.

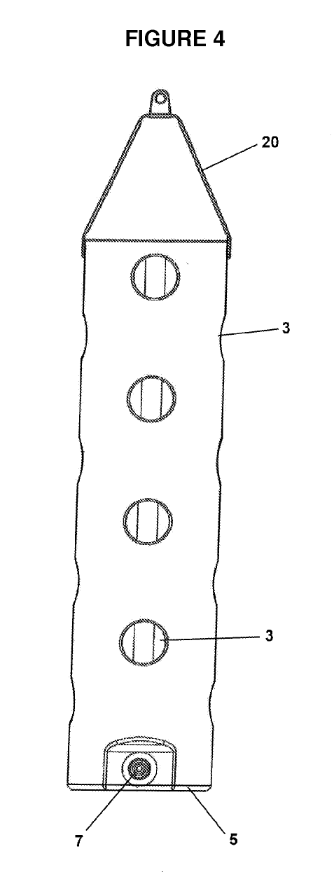

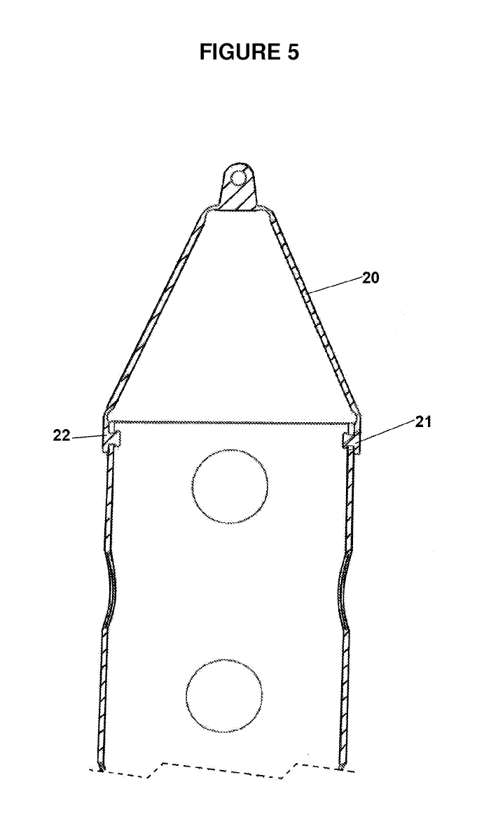

FIG. 4 illustrates a complete version of the present invention along with apertures (3), end plate (5), nipple (7) and with the additional feature of a hanging strap (20) which is illustrated in greater detail in FIG. 5.

FIG. 5 illustrates how the hanging strap (20) can be a fixed via lugs (21) into apertures (22) that are injection moulded into the multi-planter generally indicated by arrow (1).

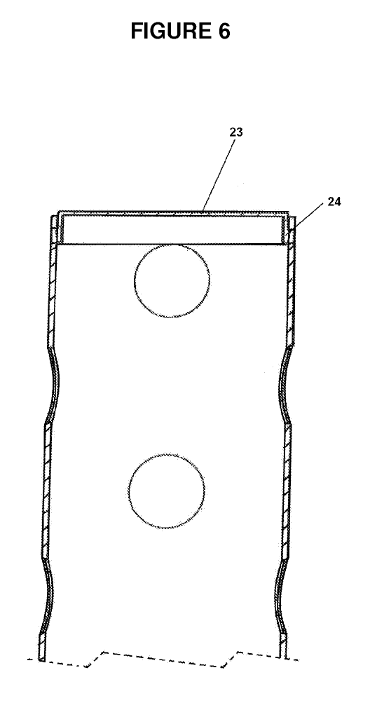

FIG. 6 illustrates an optional end cap (23) which can be used to seal the top of the container whether in a vertical or horizontal orientation. In this embodiment, the end cap (23) also includes a flange (24) which enables it to push fit into the container (1).

FIG. 7 illustrates a mounting bracket generally indicated by arrow (25) having an aperture (27) which can engage with the mounting lugs (26) illustrated in FIG. 1. The back plate (28) is substantially planar providing level support in vertical or horizontal positions.

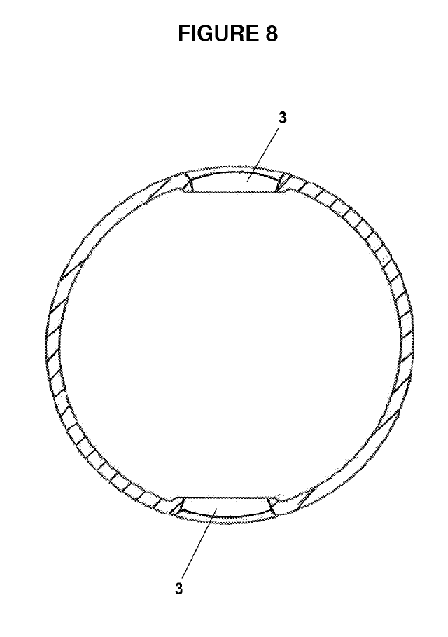

FIG. 8 illustrates the desired ratio of the thickness (T) of the uppercut in the mould around the aperture (3) in comparison to the diameter (D) of the container. Ideally this is around 0.8%.

Aspects of the present invention have been described by way of example only and it should be appreciated that modifications and additions may be made thereto without departing from the scope thereof as defined in the appended claims.

1. A method of injection moulding a multi-planter having
a tubular main body with multiple apertures in the sides thereof, and
an end cap integrally formed with the tubular main body,
the method including the step of:
inserting supports through the apertures to provide support for the internal core portion of the tool used in the injection moulding.

2. The method as claimed in claim 1 wherein the multi-planter is cylindrical in shape.

3. The method as claimed in claim 1 wherein the aperture size is between 3% and 12% of the total multi-planter wall area.

4. The method as claimed in claim 3 wherein the aperture size as a percentage of wall area is in the order of 7%.

5. The method as claimed in claim 1 wherein the apertures are in the order of 35 to 45 millimeters in diameter.

6. The method as claimed in claim 1 wherein the thickness of the walls of the multi-planter is in the order of 3 millimeters.

7. The method as claimed in claim 1 wherein the mould is constructed to provide a thickening in the wall around the apertures.

8. The method as claimed in claim 7 wherein the mould incorporates an undercut wherein the relationship between the outer perimeter and the additional thickness of the undercut in the range of 0.6% to 1%.

9. A multi-planter made according to the method in claim 1.

10. A multi-planter including:
an injection moulded tubular main body having multiple apertures therein through which plants can be placed,
support mechanisms enabling the multi-planter to be hung vertically, angled or rest horizontally, and
an end cap integrally formed with the tubular main body.

11. The multi-planter as claimed in claim 10 wherein the end cap includes a hose connection.

12. The multi-planter as claimed in claim 11 wherein the end cap is the base of the multi-planter.

13. The multi-planter as claimed in claim 10 wherein the end cap is in the form of a water reservoir.

14. The multi-planter as claimed in claim 10 which includes a capillary based mechanism to assist in distribution of water from the water reservoir into the soil as the soil dries out.

15. The multi-planter as claimed in claim 10 which includes mounting lugs.

16-17. (canceled)
